(19) United States
(12) Patent Application Publication
(10) Pub. No.: US 2023/0366478 A1
(43) Pub. Date: Nov. 16, 2023

(54) Valve device for controlled passage of a medium, in particular in the high-pressure range

(71) Applicant: ALLFI AG, Stans (CH)

(72) Inventor: Rudolf Brunner, Ennetburgen (CH)

(73) Assignee: ALLFI AG, Stans (CH)

(21) Appl. No.: 18/246,136

(22) PCT Filed: Aug. 25, 2021
(86) PCT No.: PCT/EP2021/073532

§ 371 Date: Mar. 21, 2023

(30) Foreign Application Priority Data
Sep. 23, 2020 (CH) 01207/20

(51) Int. Cl. F16K 25/04; F16K 1/38; F16K 1/42; F16K 27/02

(52) U.S. Cl. CPC F16K 25/04; F16K 1/38; F16K 1/42; F16K 27/0254; B26F 3/004

(57) ABSTRACT

The invention relates to a valve device for controlled passage of a medium, in particular in the high-pressure range, which is provided with: a housing (15) having a bore (11) and at least one inlet opening (12) and an outlet opening (13); a pressure chamber (14) which is formed in the bore (11) and can be acted upon by the medium; and a valve needle (16) which is movable to and fro therein and has a conical tip (16′). A guide means (20) for the valve needle (16), by means of which the valve needle (16) with its circumferential region (16″) is guided directly at the conical tip (16′) almost without play and concentrically with respect to the valve seat (17) until it is almost in the closed position, is located in a valve seat (17) in a valve seat block (18). This guide means (20) has passage openings (24) for the passage of the medium from the pressure chamber (14) into the outlet opening (13). Very precise guiding of the valve needle is thus achieved at the front at the tip thereof, so that the service life of the valve device can be increased.

The invention relates to a valve device for controlled passage of a medium, in particular in the high-pressure range, according to the preamble of claim 1.

With a known valve device according to document EP 3 366 963 A1, a high-pressure valve is disclosed which comprises a housing having a bore, a component housed oscillatingly therein as a valve needle, and a pressure chamber formed in the bore. The valve needle can be pressed against a valve seat in the housing by a linear actuator or a spindle nut as well as by a spindle which can be actuated by hand or by machine. The housing also has a water inlet and water outlet or vice versa, which can be connected to one another via a channel when the valve is open. Additionally, a pressure disk with a bore for guiding the valve needle when closing and opening the high-pressure valve is arranged in the housing, and a sealing element, which can be acted upon by the medium and surrounds the valve needle, is attached to this pressure chamber. The valve needle is thus guided into this pressure disk and the sealing element.

However, as the valve needle is greatly stressed with the very high operating pressures of the medium and the high cycles of operation with the many to and fro movements, there is the danger that, at the front, at the conical tip, it is not pushed flush into the valve seat very precisely, and thus a partial friction occurs between its surface on the conical tip and the valve seat, and this can lead to additional wear.

The problem of the invention is to improve this known valve device such that wear, in particular at the valve needle and the valve seat interacting with same, can be permanently prevented with a simple design, despite the heavy stresses.

This problem is solved according to the invention by the features of claim 1.

With the arrangement according to the invention of a guide means for the valve needle in the valve seat, in which the valve needle with its circumferential region is guided directly at the conical tip almost without play at least partially and concentrically with respect to the valve seat until it is in the closed position, a permanent, very precise guiding of the valve needle at the front at the tip thereof is achieved by this simple, efficient measure. The service life of the valve device can thus be increased. This guide means has at least one passage opening for the medium from the pressure chamber into the outlet opening.

Very advantageously, this guide means is designed in the shape of a collar or sleeve, and between this and the bore an annular space of the pressure chamber is formed in the housing. It is thus ensured that the medium can flow into the passage opening and into the outlet opening practically without resistance.

Preferably, the guide means contains four passage openings offset each by 90°, and in relation to the inner guide surfaces at which the circumferential region of the valve needle is guided, the openings have such a cross-sectional surface that, for one, the guiding of the valve needle is permanently ensured, and for another, a defined productive capacity of the medium flows through.

The invention, as well as further advantages of same, are illustrated below using embodiment examples with reference to the drawings. There are shown in:

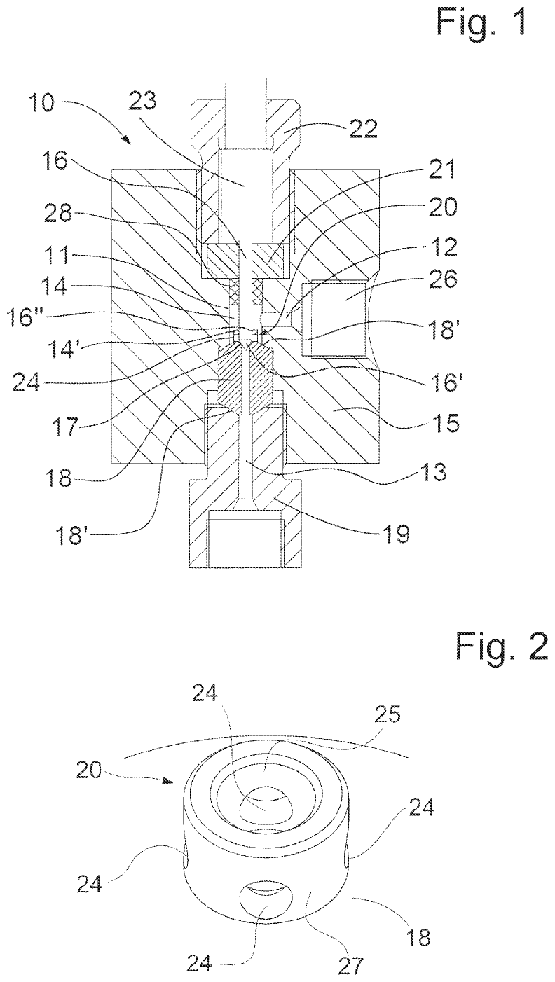

FIG. 1 is a longitudinal section of a valve device according to the invention;

FIG. 2 is a perspective view of the guide means of the valve device according to FIG. 1;

FIG. 3 is a longitudinal section of a variant of a valve device according to the invention;

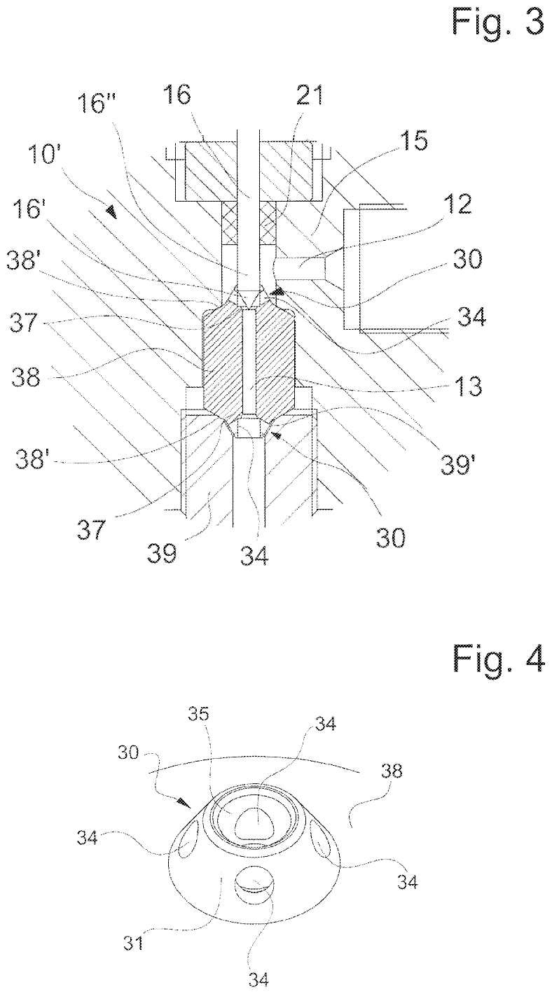

FIG. 4 is a perspective view of the guide means of the valve device according to FIG. 3;

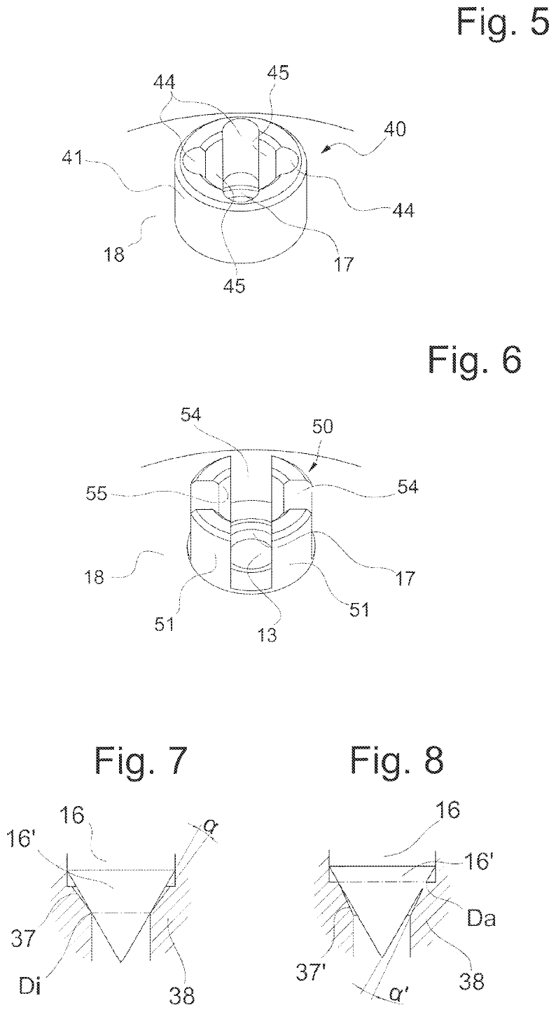

FIG. 5 is a perspective view of an alternative guide means of a valve device;

FIG. 6 is a perspective view of a further guide means of a valve device;

FIG. 7 is a partial section of a valve seat and a valve needle of the valve device according to FIG. 3; and

FIG. 8 is a partial section of the valve seat according to FIG. 7 with different tapering.

FIG. 1 shows a valve device 10 in a device for controlled passage of a medium, in particular in the high-pressure range, with pressures of up to in excess of 6000 bar. A typical range of application is devices for cutting items with a water jet provided with this high pressure.

This valve device 10 is provided with a housing 15 having a bore 11 and at least one inlet opening 12 and an outlet opening 13. In the bore 11 there is provided a pressure chamber 14 which can be acted upon by the medium and a valve needle 16 which is movable to and fro therein and has a conical tip 16′, which can be sealingly pressed against a valve seat 17 in a valve seat block 18, and thus a closing, as shown, or opening, is caused.

This valve needle 16, longitudinally guided in a sealing washer 21, has a diameter in the millimetre range and is made advantageously from a hardened metal or a high-grade ceramic material. It is connected to a spindle 23 in a spindle nut 22 in the housing 15, and can be moved to and fro by hand or by machine, for example pneumatically, from this spindle 23, and in particular is closed by a spring member and pneumatically opened. The connections from the housing for supplying the medium and driving the valve needle are not shown, but are known.

The sleeve-shaped valve seat block 18 with the valve seat 17 is formed with a conical end face 18′ on each side which, when assembled, abuts against a corresponding tapered surface in the housing 15 or alternately in a sleeve 19 which can be fastened in the housing 15 as sealing surfaces. The sleeve 19 screwed into the housing is provided with the outlet opening 13 and there can be mounted therein an outlet nozzle, not shown in more detail, for producing the water jet.

Moreover, an inlet opening 12 opening transversely into the bore 11 is provided in the housing 15, which inlet opening is coupled, in known manner, to a pressure line for supplying the pressure medium, using a connecting sleeve 26 or the like.

According to the invention, a guide means 20 for the valve seat 16 is arranged at the valve seat 17 in the valve seat block 18. This guide means 20 is designed such that the valve needle 16 with its circumferential region 16″ connecting directly thereto is guided in front of the conical tip 16′ almost without play and concentrically with respect to the valve seat 17 until it is in the closed position, wherein this guide means 20 has a number of passage openings 24 for the medium to be guided from the pressure chamber 14 into the outlet opening 13. An annular space 14′ of the pressure chamber 14 is formed between this and the bore 11 in the housing 15.

In FIG. 2, the collar-shaped or sleeve-shaped guide means 20 is shown enlarged with a cylindrical generated surface 27. A cylindrical inner guide surface 25, on which the circumferential region 16″ of the valve needle 16 is guided, is designed therein. The guide means 20 contains four passage openings 24 as bores, offset each by 90° and running approximately radially therein. In relation to the inner guide surface 25, the passage openings are dimensioned with such a cross-sectional surface that, for one, the guiding of the valve needle 16 is permanently ensured, and for another, a defined productive capacity of the medium can flow through these bores.

The overall height of the sleeve forming the guide means 20 is, within the framework of the invention, advantageously dimensioned to be greater than the total travel of the valve needle 16 measured from the valve seat 17 outwards, and the valve needle 16 is thus guided into each travel position. In principle, it would be sufficient if it is surrounded at least directly above the valve seat 17 almost without play. The bores are approximately half the size of this overall height of the guide surface 25, and are arranged in the lower region of the guide means 20, with the result that the medium can flow through until right up to the closed state. The valve needle 16 is thus guided through this sealing washer 21 and this guide means 20 twice as precisely.

In the bore 11, there is also arranged a sealing sleeve 28 and, between this and the guide means 20 spaced apart therefrom, this inlet opening 12 which runs transverse is arranged in the pressure chamber 14.

The valve seat block 18 and the guide means 20 are very advantageously produced in one piece. They are usually produced by machining with the necessary precision. The valve seat 17 and at least the inner guide surface 25 are machined in the processing machine in the same fixing, with the result that the most precise concentricity between the valve needle and the valve seat can be ensured. Theoretically, the guide means 20 could be made as a separate sleeve collar, which could be fastened to the valve seat block at the valve seat with the necessary precision.

FIG. 3 and FIG. 4 show a variant of a valve device 10′ built per se the same as that according to FIG. 1. Therefore, the same reference numbers are used for the same elements, and only the differences are displayed below. Essentially, a different valve seat block 38 is used which can be fixed into the housing 15 by means of a sleeve 39. Analogously, conical end faces 38′ are formed in this valve seat block 38, which faces each abut, when assembled, against a corresponding tapered surface in the housing or, alternately, on the sleeve 39, as sealing surfaces.

According to the invention, the collar-shaped guide means 30 is likewise designed such that the valve needle 16 with its circumferential region 16″ is guided directly at the conical tip 16′ almost without play into the inner guide surface 35 and concentrically with respect to the valve seat 37 until it is in the closed position. A number (four) of passage openings 34 for the medium to be guided are provided, which openings are oriented with their axis almost perpendicular to the one generated surface 31 forming a frustum. In so doing, optimized flow control of the medium is achieved from the pressure chamber 14 into the outlet opening 13.

This valve device 10′ is characterized in that, on either side of the valve seat block 38, each collar-shaped guide means 30, 30′ is associated with a valve seat 37, 37′. In so doing, the valve seat block 38 can be inserted into the housing 15 in two positions rotated by 180°. For this purpose, in respect of its central plane running transverse to the outlet opening 13. it is designed to be symmetrical, i.e. the conical end faces 38′ are tapered at the same angle. Thus, after a certain amount of operating time, the valve seat block 38 can be fixed rotated by 180° if the valve seat 37 and/or the guide means 30 in use is worn.

The sleeve 39 bracing the valve seat block 38 in the housing 15 is provided with a recess 39′ within the tapered surface, in which the passive guide means 30′ is located contact-free when assembled.

As a variant, the entry-side diameter of the two opposing frustum-shaped valve seats 37, 37′ at the valve seat block 38 can be different if the tapering is the same, whereas the same valve needle 16 is used with the conical tip 16′ in the position of the valve seat block 38 rotated by 180°. In so doing, the circular sealing surface at the conical tip 16′ of the valve needle 16 is changed to a closed state after rotating the valve seat block 38, and the valve needle abuts accordingly against an almost unworn circular sealing surface in the new valve seat 37′. This results in a further increase in the service life of the valve needle 16.

According to FIG. 7 and FIG. 8, different taperings of the two opposing valve seats 37, 37′ may also be provided at the valve seat block 38, whereas the same valve needle 16 with the conical tip 16′ can be used in the position of the valve seat block 38 rotated by 180°, with the result that the circular sealing surface at the conical tip 16′ of the valve needle 16 changes after the valve seat block 38 has rotated. As illustrated in FIG. 7 or FIG. 8, the valve needle 16 rests against the inner or outer diameter Di or Da with this different angle of inclination a, a′ of the respective frustum-shaped sealing surface of the valve seat 37 by a small angle value of approx. between 1 and 10°. If the valve needle 16 at its valve seat 16′ is worn at diameter Di, this is not the case at Da in its upper region.

In principle, either a different entry-side diameter or a different tapering to the previous one could be provided also when changing a valve seat block 18 with only one guide means 20, as shown in FIG. 1, to a new valve seat block with a guide means on only one or both side(s), meaning the same effect results as explained above with the valve seat block 38 with a valve seat 37, 37′ on each side.

In the further embodiment example according to FIG. 5, a sleeve-shaped guide means is shown which can be arranged with the valve seat 17 in the valve seat block 18 similar to that according to FIG. 1. The special feature forming the difference is the cylindrical generated surface 41 and passage openings 44 over the whole circumference, designed as recesses inside the generated surface 41 parallel to and spaced apart from the central axis. Segment-shaped inner guide surfaces 45 are thus formed in which the valve needle 16 with its circumferential region 16″ is guided almost without play and concentrically with respect to the valve seat 17 until it is in the closed position. These recesses, and correspondingly the inner guide surfaces 45, could also be produced arranged in helical rows.

FIG. 6 shows a sleeve-shaped guide means 50 which can also be arranged in the valve seat 17 in valve seat block 18, like that according to FIG. 1. The difference lies in these slot-shaped passage openings 54, which are designed permanently crosswise. Thus, similar to with guide means 40, segment-shaped inner guide surfaces 55 of segments 51 are formed into which the valve needle 16 is guided. The number of these slot-shaped passage openings 54 could also be more or less than four, and the size of same could also be less than that of the overall height.

The invention illustrated sufficiently with the above embodiment examples could self-evidently also be displayed using further variants. In this way, this guide means could be guided outwards to the bore and fastened in the housing and/or at the valve seat block. Slots or recesses would then be designed as openings of the guide means, as shown in FIG. 5 and FIG. 6.

The guide means could also be cup-shaped, dome-shaped or the like, and the preferably several passage openings could each be developed in their cross-sectional form and/or differently aligned to how they are shown.

With the two guide means 30 according to FIG. 3, such guide means according to the other Figures or two different guide means could be used, if for example a change is necessary for reasons of air flow.

1. A valve device for controlled passage of a medium, in particular in the high-pressure range, which device is provided with a housing (15) having a bore (11) with at least one inlet opening (12) and one outlet opening (13), with a pressure chamber (14) which is formed in the bore (11) and can be acted upon by the medium, and a valve needle (16) which is movable to and fro therein and has a conical tip (16′), which can be sealingly pressed against a valve seat (17) in a valve seat block (18) or in the housing (15), characterized in that a guide means (20, 30, 40, 50) for the valve needle (16), by means of which the valve needle (16) with its circumferential region (16″) is guided directly at the conical tip (16′) almost without play and concentrically with respect to the valve seat (17) until it is almost in the closed position, is located in a valve seat (17) in the valve seat block (18) or in the housing (15), wherein this guide means (20, 30, 40, 50) has at least one passage opening (24, 34, 44, 54) for the passage of the medium from the pressure chamber (14) into the outlet opening (13).

2. The valve device according to claim 1, characterized in that the guide means (20, 30, 40, 50) is formed in the shape of a collar or sleeve, and between this and the bore (11) an annular space (14′) of the pressure chamber (14) is formed in the housing (15).

3. The valve device according to claim 1, wherein, depending on the development of its passage opening (24, 34, 44, 54), the guide means (20, 30, 40, 50) is designed with discontinuous cylindrical or segment-shaped inner guide surfaces (25, 35, 45, 55), on which the circumferential region (16″) of the valve needle (16) is guided.

4. The valve device according to claim 1, wherein the guide means (20, 30, 40, 50) is provided with several passage openings (24, 34, 44, 54) connecting the pressure chamber (14) to the outlet opening (13) as bores, slots and/or recesses.

5. The valve device according to claim 1, wherein the guide means (20, 30, 40, 50) has a cylindrical, cone-shaped or otherwise shaped outer generated surface (27, 31, 41), and the several passage openings (24, 34, 44, 54) run radially and/or tangentially or at an angle thereto.

6. The valve device according to claim 4, wherein the guide means (20, 30, 40, 50) contains four passage openings (24, 34, 44, 54) offset each by 90°, and in relation to the inner guide surfaces, the cross-sectional surfaces of which openings are such that, for one, the guiding of the valve needle (16) is permanently ensured, and for another, a defined productive capacity of the medium flows through.

7. The valve device according to claim 4, wherein the generated surface (31) of the guide means (30) are designed to be cone-shaped and the passage openings (34) as bores which extend with their axes approximately perpendicular to the generated surface (31) in radial direction.

8. The valve device according to claim 4, wherein the generated surface (41) of the guide means (40) are designed cylindrical, and the passage openings (44) within the generated surface (41) are parallel and spaced apart from the central axis.

9. The valve device according to claim 4, wherein the passage openings (54) are designed as radial slots and the guide means (50) consists of segments (51).

10. The valve device according to claim 1, wherein the valve seat block (18, 38) or the housing (15) and the guide means (20, 30, 40, 50) are each made of one piece, or that each of the guide means is provided as a separate sleeve collar, fastened in the housing or to the valve seat block in the valve seat.

11. The valve device according to claim 1, wherein the sleeve-shaped valve seat block (18, 38) is formed with conical end faces (18′, 38′) which, when assembled, interact with corresponding tapered surfaces in the housing (15) and alternately in a fastenable sleeve (19, 39) as sealing surfaces.

12. The valve device according to claim 1, further comprising a guide means (30) with a valve seat (37) assigned on either side of the valve seat block (38), with the result that this valve seat block (38) is configured to be insertable into the housing (15) in two positions rotated about 180°.

13. The valve device according to claim 12, characterized in that the valve seat block (38) is designed to be symmetrical in respect of its central plane running transverse to the outlet opening (13), and therefore its conical end surfaces (38′) are tapered at the same angle.

14. The valve device according to claim 12, characterized in that the diameters of the two opposing valve seats (37, 37′) on the valve seat block (38) are of different size but have the same tapering, whereas the same valve needle (16) with the conical tip (16′) can be used when the valve seat block (38) is rotated by 180°, with the result that, after rotating the valve seat block (38), the circular sealing surface changes with the conical tip (16′) of the valve needle (16), and thus in the closed state the valve needle abuts against the valve seat (37′) with an unworn circular sealing surface.

15. The valve device according to claim 12, characterized in that the tapering at least of the at least one valve seat (17, 37, 37′) is formed on the valve seat block (18, 38) by a different angle of inclination (α, α′) compared with the conical tip (16′) of the valve needle (16), or that the taperings of the two opposite valve seats (37, 37′) of the valve seat block (38) are each formed by a different angle of inclination (α, α′) compared with the conical tip (16′), whereas the same valve needle (16) can be used in the position of the valve seat block (38) rotated by 180°, with the result that the circular sealing surface in the conical tip (16′) of the valve needle (16) changes after rotating the valve seat block (38).

16. The valve device according to claim 1, wherein the valve needle (16) is guided additionally through a sealing washer (21) in the housing (15) and connects to a sealing sleeve (28) in the bore (11), between which sleeve and the guide means (20, 30, 40, 50) spaced apart therefrom the at least one inlet opening (12) opening laterally into the pressure chamber (14) is arranged.

17. The valve device according to claim 1, wherein the overall height of the inner guide surfaces (25, 35, 45, 55) of the guide means (20, 30, 40, 50) is dimensioned to be greater than the total travel of the valve needle (16) measured from the valve seat (17) outwards, and the valve needle (16) is thus guided into each travel position.

18. The valve device according to claim 1, wherein the valve needle (16) is made from a hardened metal, hard metal and/or a ceramic material.
